(19) United States
(12) Patent Application Publication
(10) Pub. No.: US 2015/0207721 A1
(43) Pub. Date: Jul. 23, 2015

(54) METHOD AND SYSTEM FOR GENERATING MULTI-PROTOCOL FAULT MANAGEMENT PACKET BY USING FPGA

(71) Applicant: Celestica Technology Consultancy (Shanghai) Co., Ltd., Shanghai (CN)

(72) Inventors: Fang-Hao Fan, Shanghai (CN); Jian-Kun Zhou, Shanghai (CN)

(73) Assignee: Celestica Technology Consultancy (Shanghai) Co., Ltd., Shanghai (CN)

(21) Appl. No.: 14/531,603

(22) Filed: Nov. 3, 2014

(30) Foreign Application Priority Data
Jan. 17, 2014 (CN) 201410023149.1

(51) Int. Cl. H04L 12/26

(52) U.S. Cl. CPC H04L 43/50

(57) ABSTRACT

Disclosed is a method for generating a multi-protocol fault management (FM) packet by using a field-programmable gate array, including: setting information related to FM in a plurality of local maintenance entity group end points (LMEPs); performing a polling process of the plurality of LMEPs according to the packet types after obtaining send instructions related to a certain packet type; determining a protocol type of the plurality of LMEPs; obtaining information related to the protocol type; acquiring information related to the packet type under the protocol type; generating a corresponding number of FM packets in accordance with the information related to the protocol type and the at least one set of field information related to the packet types; and outputting the FM packets. The method enables transmission of CCM, LCK and AIS packets under ETH, ITU and IETF packets to be achieved. Therefore, compatibility and competitiveness of products are improved.

### CROSS-REFERENCES TO RELATED APPLICATIONS

This application claims the priority of Chinese patent application No. 201410023149.1, filed on Jan. 17, 2014, which is incorporated herewith by reference.

### BACKGROUND OF THE INVENTION

1. Field of the Invention

The present invention relates to a computer network, and more particularly, to a method and a system for generating a multi-protocol fault management (FM) packet by using a field-programmable gate array (FPGA).

2. The Prior Arts

Local maintenance entity group end point (LMEP) is used to inspect and maintain networks. The fault management (FM) packet is a packet used in the LMEP. Generally, the FM packet may be a continuity check message (CCM) packet, an alarm indication signal (AIS) packet and a lock (LCK) packet. The AIS packet provides a means to alert the failed end-to-end link. The LCK packet provides a means to lock a signal. In addition, the CCM packet provides a means to detect connectivity failures in a maintenance association end point (MEP). Connectivity failures may be caused by mechanical failures or configuration errors.

With regard to the Internet engineering task force (IETF) protocol, the LCK packet is called a lock instruction (LI) packet. Moreover, the CCM packet may be a bidirectional forwarding detection (BFD) packet or a label switched path (LSP) packet. As such, different protocols may correspond to different FM packet formats. In the same protocols, different FM packets may correspond to different protocol data unit (PDU) formats. However, other parts of the protocols may be the same.

A field-programmable gate array (FPGA) is a general programmable gate array device, which was developed by Xilinx in 1984. The FPGA includes gate array devices having high integration and versatility. The FPGA may be configured by a designer or a customer, thereby having the advantage of flexibility. In other words, the FPGA enables logical units, bidirectional data buses, I/O units to be configured by a designer or a customer so as to achieve any logical functions and different requirements. Complex functions and systems may be achieved by the FPGA due to its high speed, low power and high degree of versatility. Moreover, the FPGA may achieve dynamic configuration, system re-configuration (the circuits may be modified via timing analysis and space analysis when the system is running), software-defined hardware, hardware-defined software, and so on.

Further, in different protocols, the formats and lengths of packets are different. Therefore, for the sake of meeting the requirement of sending the FM packets in different protocol types, it is necessary to provide an alternative method for generating a multi-protocol FM packet by using a FPGA.

### SUMMARY OF THE INVENTION

In light of the foregoing drawbacks, an objective of the present invention is to provide a method and a system for generating a multi-protocol fault management (FM) packet by using a field-programmable gate array (FPGA), thereby enabling data communication products to be tested by using low-cost testing equipment.

For achieving the foregoing objective, the present invention provides a method for generating a multi-protocol FM packet by using a FPGA, including the steps of setting information related to FM in a plurality of local maintenance entity group end points (LMEPs), wherein the information related to FM includes a protocol type, information related to the protocol type and information related to packet types; information related to each of the packet types includes at least one set of field information related to the packet types; and a set of field information related to the packet types is used to generate a packet having the packet types; performing a polling process of the plurality of LMEPs according to the packet types after obtaining send instructions related to a certain packet type; and processing each of the plurality of LMEPs, wherein the step of processing each of the plurality of LMEPs includes the steps of determining a protocol type of the plurality of LMEPs; obtaining information related to the protocol type; acquiring information related to the packet type under the protocol type; generating a corresponding number of FM packets in accordance with the information related to the protocol type and the at least one set of field information related to the packet types; and outputting the FM packets.

Preferably, the method of the present invention further includes a step of executing the send instructions to ensure that each of the send instructions has sufficient time to complete.

Preferably, the method of the present invention further includes a step of modifying information related to the FM packets in the plurality of LMEPs.

Preferably, the method of the present invention further includes steps of acquiring enable information of the packet types and determining whether the FM packets are generated according to the enable information. In addition, the information related to the FM packets includes the enable information of the packet types.

Preferably, the method of the present invention further includes a step of outputting the FM packets to an output cache.

Preferably, the packet types include a continuity check message (CCM) packet, a lock (LCK) packet and an alarm indication signal (AIS) packet.

Preferably, the protocol type includes an Ethernet (ETH) protocol, an international telecommunication union (ITU) protocol and an Internet engineering task force (IETF) protocol.

Preferably, the information related to the plurality of LMEPs includes the steps of generating a set of information corresponding to the CCM packet, generating a set of information corresponding to the LCK packet and generating eight sets of information corresponding to the AIS packet.

According to the present invention, the present invention further provides a system for generating a FM packet by using a FPGA. The system of the present invention includes a local maintenance entity group end point (LMEP) module includes a plurality of LMEPs, wherein each of the plurality of LMEPs includes information related to FM, the information related to FM includes a protocol type, information related to the protocol type and information related to packet types; information related to each of the packet types includes at least one set of field information related to the packet types; and a set of field information related to the packet types is used to generate a packet having the packet types; an instruction control module connected to the LMEP module and performing a polling process of the plurality of LMEPs according to the packet types after obtaining send instructions related to a certain packet type, wherein processing each of the plurality of LMEPs includes determining whether a FM packet is generated; and a packet frame module connected to the LMEP module and the instruction control module, wherein generated information is sent to the packet frame module if the FM packet is generated; a corresponding number of FM packets is generated in accordance with obtaining the generated information, acquiring information related to the protocol type of the plurality of LMEPs and at least one set of field information related to the packet types; and the FM packets are outputted.

Preferably, the system of the present invention further includes a LMEP modification module connected to the LMEP module, and setting and modifying information related to the FM packets in the plurality of LMEPs of the LMEP module.

Preferably, the system of the present invention further includes an output cache module connected to the packet frame module, obtaining the FM packets outputted by the packet frame module and output caching the FM packets.

As described above, the method and the system for generating a FM packet by using a FPGA may bring about the following technical effects. Transmissions of a CCM packet, a LCK packet and an AIS packet are achieved under three protocols (ETH, ITU and IETF) by a FPGA. As such, compatibility and competitiveness of products are effectively improved.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a block diagram illustrating a system for generating a multi-protocol fault management (FM) packet by using a field-programmable gate array (FPGA) according to the present invention; and

FIG. 2 is a flow chart showing a method for generating a multi-protocol FM packet by using a FPGA according to the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the present invention.

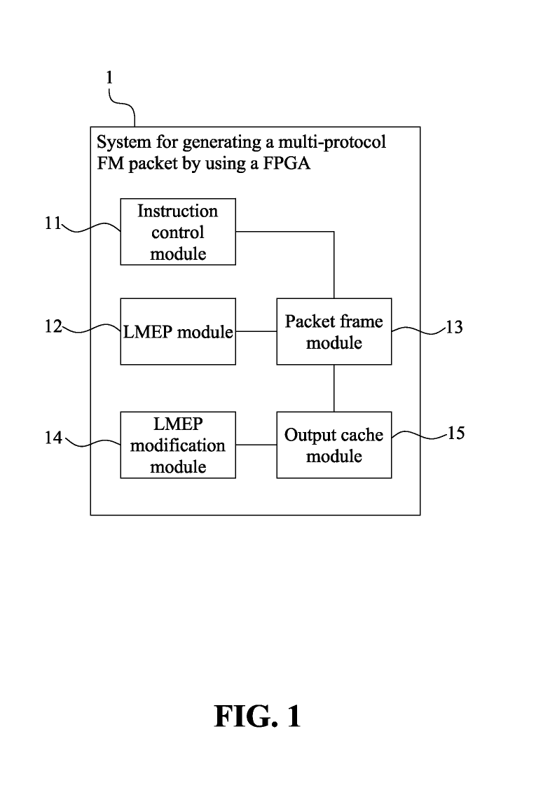

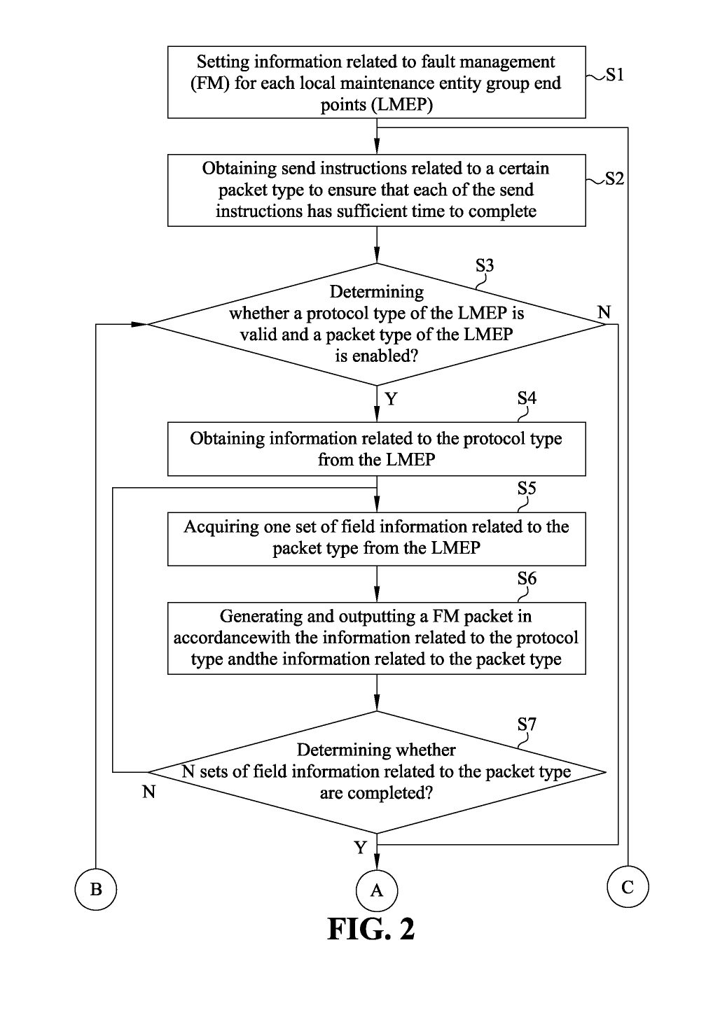

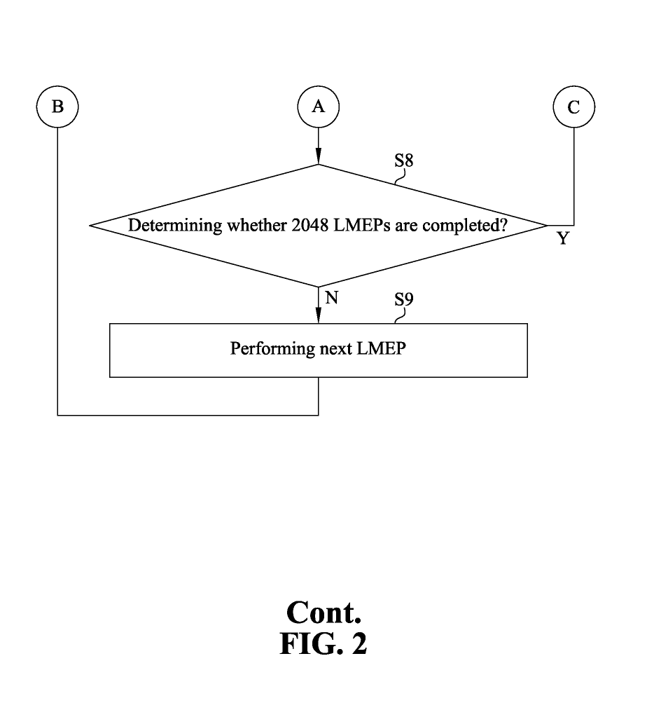

With regard to FIGS. 1 and 2, the drawings showing embodiments are semi-diagrammatic and not to scale and, particularly, some of the dimensions are for clarity of presentation and are shown exaggerated in the drawings. Similarly, although the views in the drawings for ease of description generally show similar orientations, this depiction in the drawings is arbitrary for the most part. Generally, the present invention can be operated in any orientation.

In light of the foregoing drawings, an objective of the present invention is to provide a method for generating a multi-protocol fault management (FM) packet by using a field-programmable gate array (FPGA). The method of the present invention includes the steps of setting information related to FM in a plurality of local maintenance entity group end points (LMEPs), wherein the information related to FM includes a protocol type, information related to the protocol type and information related to packet types; information related to each of the packet types includes at least one set of field information related to the packet types; and a set of field information related to the packet types is used to generate a packet having the packet types; performing a polling process of the plurality of LMEPs according to the packet types after obtaining send instructions related to a certain packet type; and processing each of the plurality of LMEPs, wherein the step of processing each of the plurality of LMEPs includes the steps of determining a protocol type of the plurality of LMEPs; obtaining information related to the protocol type; acquiring information related to the packet type under the protocol type; generating a corresponding number of FM packets in accordance with the information related to the protocol type and the at least one set of field information related to the packet types; and outputting the FM packets.

According to the present invention, the FPGA includes 2048 LMEPs. Each of the plurality of LMEPs includes a LMEP table to store information related to the FM packet that is required to be sent. The information related to the FM packet includes the following fields: a protocol type field, information related to a protocol type, packet type enable information and information related to a packet type.

For the protocol type field, the protocol type includes an ETH protocol, an ITU protocol and an IETF protocol. The field related to the protocol type includes a protocol type of information related to the FM packet corresponding to each of field information in a data packet. For example, an ETH packet includes a source address, a target address, type/length, and so on. The packet type field includes a CCM packet, a LCK packet and an AIS packet. These three packets belong to the FM packet. Moreover, the CCM packet of the IETF protocol may be a BFD packet and a LSP packet. The LCK packet of the IETF protocol may be called a LI packet. The same packet type field under different protocols may correspond to different related information. In addition, different packet type fields under the same protocol may also correspond to different related information. For example, referring to the rules for some protocols, a protocol ITU-T Y.1731 specifies rules describing all FM packets of ETH. A protocol ITU-T G8113.1 specifies rules describing all FM packets of ITU. A protocol RFC 5880 specifies rules describing BFD packets of IETF. A protocol RFC 4379 specifies rules expressing LSP packets of IETF. A protocol RFC 6427 specifies rules describing AIS packets of IETF. Moreover, a protocol RFC 6435 expressing LI packets of IETF. The information related to the packet type is usually a protocol data unit (PDU) field. In a protocol, the PDU filed may be called a data field. BM packets and LSP packet may also include a Label field.

The information related to the packet type may include multiple sets of information. Each set of information may correspond to a PDU field; that is, the corresponding content in a data field. Accordingly, the content of LMEP table in a LMEP may include multiple sets of information of certain packets, thereby generating multiple packets. According to the present invention, the content of a LMEP may include generating a set of information corresponding to the CCM packet, generating a set of information corresponding to the LCK packet and generating eight sets of information corresponding to the AIS packet. The non-PDU fields of the packet in the same type and same protocol may be shared.

As shown in FIG. 2, the method of the present invention may include the following steps.

Firstly, in step S1, the step of setting information related to FM for each LMEP; that is, the content of each LMEP. Then, proceed to step S2.

In step S2, send instructions related to a certain packet type (such as sending a CCM packet) is obtained. As such, in order to ensure that each of the send instructions has sufficient time to complete, the instructions with respect to the sent CCM packet are executed by means of a pulse having an interval 3.3 ms sent regularly by a FPGA. In other words, the send instructions may be executed in accordance with the pulse appeared. On this occasion, it may interleave the transmission times of CCM, AIS and LCK packets. Each of those packets may be sent during a pulse having an interval 3.3 ms. When a pulse is generated, the LMEP table is performed to ensure that CCM, AIS and LCK packets are sent in different pulses. Moreover, all the send instructions including the packet type may be completed in sufficient time, such as 3.3 ms. The send instructions are executed subsequently.

A polling process of 2048 LMEPs may be performed in accordance with the packet types. In other words, 2048 LMEPs may be performed by executing steps S1-S8. A counter is usually used as an index of each of the plurality of LMEPs. The plurality of LMEPs may be executed by starting from the first LMEP.

In step S3, the content of the protocol type field of the LMEP is acquired. It is determined whether a protocol type of the LMEP is valid and a packet type of the LMEP is enabled. If information of the protocol type field shows that the protocol type of the LMEP is invalid and the packet type of the LMEP is disabled, proceed to step S8. Otherwise, if information of the protocol type field shows that the protocol type of the LMEP is valid and the packet type of the LMEP is disabled, proceed to step S4.

In step S4, information related to the protocol type from the LMEP is obtained. The information related to the protocol type shows that those related information under a certain protocol type packet of the protocol is shared in addition to PDU (not including a check field FCS). The shared portions in different types of packets under the ETH protocol are the same. Moreover, the shared fields in the packets under the ITU and IETF protocols are related to the packet type. In other words, under the IETF protocol, the Label fields are shared fields, but the value of Label fields of the BFD packet and the LSP packet are different, and may correspond to different fields of LMEP. As such, the value of Label field of the BFD packet may correspond to a GAL Label field of LMEP, and the value of Label field of the LSP packet may correspond to a LSP Label field of LMEP. Then, proceed to step S5.

In step S5, one set of field information related to the packet type from the LMEP is acquired. That is to say, field information related to the packet type may correspond to a related field in PDU of the packet type, and may include a non-PDU field if necessary. For example, PDU of the AIS packet under ETH and ITU may includes MEL, version, OpCode, label, TLV offset, end TLV, of which the version, OpCode, label, TLV offset and end TLV may be set as default. The fields having default may not have corresponding fields in LMEP. However, MEL and label may correspond to the fields in a set of field information related to the packet type of LMEP if not having default, for example. Then, proceed to step S6.

According to the present invention, in step S6, a FM packet is generated and outputted in accordance with the information related to the protocol type and the information related to the packet type. In other words, information related to the protocol type and field information related to the packet type are correspondingly filled in each field of the packet type related to the protocol type. A FM packet is generated and outputted according to the information related to the protocol type and the information related to the packet type. For example, with regard to an AIS type packet, if the LMEP is an ETH protocol, an AIS packet of the ETH protocol may be generated based on the obtained related information. Therefore, such AIS packet is also a FM packet. After that, the FM packet is outputted, or firstly the FM packet is transmitted to a cache, and the FM packet stored in the cache is outputted subsequently. Then, proceed to step S7.

In step S7, it is determined whether N sets of field information related to the packet type are completed. That is to say, each LMEP has eight sets of information corresponding to the AIS packet. If the packet type is AIS, it is determined whether these eight sets of information related to the AIS packet are completed. If not completed, proceed to step S6 for generating a packet of the packet type. If completed, proceed to step S8.

In step S8, it is determined whether 2048 LMEPs are completed. If completed, the send instruction is completely executed. Then, proceed to step S2, and wait for the next send instruction to execute. If not completed, proceed to step S9.

In step S9, the next LMEP is performed. In other words, the next LMEP may be performed. Then, proceed to step S3.

Moreover, the present invention further includes s a step of modifying information related to the FM packets in the plurality of LMEPs. That is, the output packet field information may be modified.

Referring to FIG. 1, the present invention further provides a system 1 for generating a multi-protocol FM packet by a FPGA. The system 1 includes an instruction control module 11, a LMEP module 12 and a packet frame module 13.

According to the present invention, the LMEP module 12 includes a plurality of LMEPs. Each of the plurality of LMEPs includes information related to FM, the information related to FM includes a protocol type, information related to the protocol type and information related to packet types. Information related to each of the packet types includes at least one set of field information related to the packet types. A set of field information related to the packet types is used to generate a packet having the packet types.

Moreover, the instruction control module 11 is connected to the LMEP module 12 and the packet frame module 13, and performs a polling process of the plurality of LMEPs according to the packet types after obtaining send instructions related to a certain packet type. Processing each of the plurality of LMEPs includes a step of determining whether a FM packet is generated

According to the present invention, the packet frame module 13 is connected to the instruction control module 11 and the LMEP module 12. Generated information is sent to the packet frame module if the FM packet is generated. A corresponding number of FM packets is generated in accordance with obtaining the generated information, acquiring information related to the protocol type of the plurality of LMEPs and at least one set of field information related to the packet types. Accordingly, the FM packets are outputted. In other words, a number of FM packets may be generated based on obtaining the generated information, acquiring information related to the protocol type of the plurality of LMEPs and at least one set of field information related to the packet type. In the present invention, the packet type may be AIS. A LMEP includes eight sets of field information related to AIS. Accordingly, eight AIS packets are generated and outputted in accordance with the information related to the protocol type, public information and eight sets of field information related to AIS (i.e., information related to the PDU field).

The system 1 for generating a multi-protocol FM packet by using a FPGA may further include a LMEP modification module 14 connected to the LMEP module 12, and setting and modifying information related to the FM packets in the plurality of LMEPs of the LMEP module 12. In other words, the LMEP modification module 14 may modify information related to the FM packets in the plurality of LMEPs of the LMEP module 12. As such, the packet's field information outputted by the plurality of LMEPs may be modified.

In addition, the system 1 for generating a multi-protocol FM packet by using a FPGA may further include an output cache module 15 connected to the packet frame module 13, may obtain the FM packets outputted by the packet frame module 13, and may output caching the FM packets. In other words, the packet frame module 13 may output the generated FM packets to the output cache module 15, and then the output cache module 15 may cache the FM packets.

From the above, the present invention provides a method and a system for generating a multi-protocol FM packet by using a FPGA. Transmission of ETH, ITU and IETF packets may be achieved in a FPGA. That is to say, after obtaining one of CCM, LCK and AIS packet types, transmission of a packet related to one of the packet types in a LMEP may be completed in 3.3 ms. Accordingly, compatibility and competitiveness of products may be effectively improved. Therefore, it is clear that the present invention may effectively overcome the aforementioned prior-art issues, and has industrial applicability.

The above exemplary embodiment describes the principle and effect of the present invention, but is not limited to the present invention. It will be apparent to those skilled in the art that various modifications and variations can be made to the disclosed embodiments. It is intended that the specification and examples be considered as exemplary only, with a true scope of the disclosure being indicated by the following claims and their equivalents.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for generating a multi-protocol fault management (FM) packet by using a field-programmable gate array (FPGA), comprising the steps of:
setting information related to FM in a plurality of local maintenance entity group end points (LMEPs), wherein the information related to FM comprises a protocol type, information related to the protocol type and information related to packet types; information related to each of the packet types comprises at least one set of field information related to the packet types; and a set of field information related to the packet types is used to generate a packet having the packet types;
performing a polling process of the plurality of LMEPs according to the packet types after obtaining send instructions related to a certain packet type; and
processing each of the plurality of LMEPs, wherein the step of processing each of the plurality of LMEPs comprises the steps of determining a protocol type of the plurality of LMEPs; obtaining information related to the protocol type; acquiring information related to the packet type under the protocol type; generating a corresponding number of FM packets in accordance with the information related to the protocol type and the at least one set of field information related to the packet types; and outputting the FM packets.

2. The method according to claim 1, further comprising a step of executing the send instructions to ensure that each of the send instructions has sufficient time to complete.

3. The method according to claim 1, further comprising a step of modifying information related to the FM packets in the LMEPs.

4. The method according to claim 1, further comprising steps of acquiring enable information of the packet types, and determining whether the FM packets are generated according to the enable information, wherein the information related to the FM packets comprises the enable information of the packet types.

5. The method according to claim 1, further comprising a step of outputting the FM packets to an output cache.

6. The method according to claim 1, wherein the packet types comprise a continuity check message (CCM) packet, a lock (LCK) packet and an alarm indication signal (AIS) packet.

7. The method according to claim 1, wherein the protocol type comprises an Ethernet (ETH) protocol, an international telecommunication union (ITU) protocol and an Internet engineering task force (IETF) protocol.

8. The method according to claim 1, wherein the information related to the LMEPs comprises the steps of generating a set of information corresponding to the CCM packet, generating a set of information corresponding to the LCK packet and generating eight sets of information corresponding to the AIS packet.

9. A system for generating a multi-protocol fault management (FM) packet by using a field-programmable gate array (FPGA), comprising:
a local maintenance entity group end point (LMEP) module comprises a plurality of LMEPs, wherein each of the plurality of LMEPs comprises information related to FM, the information related to FM comprises a protocol type, information related to the protocol type and information related to packet types; information related to each of the packet types comprises at least one set of field information related to the packet types; and a set of field information related to the packet types is used to generate a packet having the packet types;
an instruction control module connected to the LMEP module and performing a polling process of the plurality of LMEPs according to the packet types after obtaining send instructions related to a certain packet type, wherein processing each of the plurality of LMEPs comprises determining whether a FM packet is generated;
a packet frame module connected to the LMEP module and the instruction control module, wherein generated information is sent to the packet frame module if the FM packet is generated; a corresponding number of FM packets is generated in accordance with obtaining the generated information, acquiring information related to the protocol type of the plurality of LMEPs and at least one set of field information related to the packet type; and the FM packets are outputted.

10. The system according to claim 9, further comprising a LMEP modification module connected to the LMEP module, and setting and modifying information related to the FM packets in the plurality of LMEPs of the LMEP module.

11. The system according to claim 9, further comprising an output cache module connected to the packet frame module, obtaining the FM packets outputted by the packet frame module and output caching the FM packets.
